(19) United States
(12) Patent Application Publication
(10) Pub. No.: US 2020/0267487 A1
(43) Pub. Date: Aug. 20, 2020

(54) DYNAMIC SPATIAL AUDITORY CUES FOR ASSISTING EXERCISE ROUTINES

(71) Applicant: BOSE CORPORATION, Framingham, MA (US)

(72) Inventor: Navaneethan Siva, Waltham, MA (US)

(21) Appl. No.: 16/275,946

(22) Filed: Feb. 14, 2019

(51) Int. Cl. H04S 7/00; H04R 1/10; A63B 24/00

(52) U.S. Cl. CPC H04S 7/30; A63B 24/0087; H04R 1/1091

(57) ABSTRACT

A headphone system includes headphones including a right-side earpiece including a right-side audio driver and a left-side earpiece including a left-side audio driver. The headphone system further includes a sensor to provide a sensor signal indicative of one of an aspect of movement of a user wearing the headphones or a value of a physiological parameter of the user; a controller configured to output an audio signal via the headphones, and a detection circuit configured to receive the sensor signal and to provide feedback based on the one of the aspect of movement of the user or the value of the physiological parameter, the feedback including a location of a source of the audio signal perceived by the user.

### BACKGROUND

With the rise in popularity of personal fitness tracking and applications to help guide workouts, there is a desire for a more integrated experience. It would be desirable to provide a system that helps guide the user through an exercise routine to achieve a desired pace or program without having to keep the phases of their program in mind or to have to stop progress to refer to a smart device to remind themselves.

Many runners use headphone systems while running, and for various purposes, such as listening to audio content (e.g., music, talk), communications (e.g., telephone calls), and/or noise reduction. Headphone systems may therefore provide a platform for advantageous use as an exercise routine feedback device.

### SUMMARY

Aspects and examples are directed to headphone systems and methods that detect aspects of a user's activity, such as running, and that may provide feedback to the user about the user's performance. Feedback may be provided through modification of audio content rendered through headphones worn by the user. In some examples, audio content provided through the headphones of a user performing an exercise routine may be modulated to provide a virtual audio source at which the user perceives the audio content as being rendered. If the user is performing the exercise routine below a desired pace, for example, as determined from a measurement of the pace, heartrate, or respiration of the user being below a desired level, the virtual audio source may be provided in front of the user, encouraging the user to increase the exercise pace and “catch up” to the audio source. If the user is performing the exercise routine at above a desired pace, for example, as determined from a measurement of the pace, heartrate, or respiration of the user being above a desired level, the virtual audio source may be provided behind the user, encouraging the user to slow down.

According to one aspect, a headphone system is provided that includes a pair of earpieces, acoustic drivers coupled to the earpieces to render an audio signal, a sensor to provide a sensor signal indicative of an aspect of the user's movement, and a detection circuit configured to receive the sensor signal and to provide feedback to the user through the headphones based at least upon the aspect of movement of the user.

In various examples, the sensor may be a microphone to detect an acoustic signal indicative of one or more of footfalls of the user, breathing sounds of the user, or the heartrate of the user. The sensor may be an inertial sensor or accelerometer to detect accelerations associated with footfalls of the user or a speed or pace of movement of the user. The sensor may be an optical or conductance sensor capable of measuring a heartrate or blood oxygen level of the user. Several different sensor types may be used in conjunction to determine a physical state of the user or parameters associated with the exercise routine of the user. According to another aspect, a method of providing feedback to a headphone user is provided that includes receiving an audio signal to be converted to an acoustic signal, receiving a sensor signal indicative of an aspect of movement or a physical state of the user, analyzing the sensor signal to detect the aspect of the movement or physical state of the user, and providing feedback to the user based upon the aspect of the movement or physical state of the user.

Providing feedback may include modifying the audio signal and rendering the modified audio signal through the headphones. Modifying the audio signal may include modifying a location of a virtual source from which the user perceives the audio signal as originating.

In various examples, the sensor signal may include one or more of an acoustic signal, a microphone signal, an accelerometer signal, an impact signal, a force indicating signal, or a signal indicative of one or more physiological parameters of the user. The sensor signal may be indicative of the user's pace, stride, heartrate, blood oxygen level, or respiration rate.

In accordance with one aspect, there is provided a headphone system. The headphone system comprises headphones including a right-side earpiece including a right-side audio driver and a left-side earpiece including a left-side audio driver. The headphone system further includes a sensor to provide a sensor signal indicative of one of an aspect of movement of a user wearing the headphones or a value of a physiological parameter of the user; a controller configured to output an audio signal via the headphones, and a detection circuit configured to receive the sensor signal and to provide feedback based on the one of the aspect of movement of the user or the value of one or more physiological parameters, the feedback including a location of a source of the audio signal perceived by the user.

In some examples, the controller is configured to determine an exercise pace of the user based on measurements from the sensor of the aspect of movement of the user. The controller may be configured to compare one aspect of the exercise pace of the user to a target exercise pace or the value of the physiological parameter to a target physiological parameter value and to adjust the perceived location of the source of the audio signal based on a result of the comparison. The controller may be configured to set the perceived location of the audio signal in front of the user responsive to one of the exercise pace of the user being below the target exercise pace or the physiological parameter having a value below a target value. The controller may be configured to set the perceived location of the audio signal behind the user responsive to the exercise pace of the user being above the target exercise pace or the physiological parameter having a value above a target value.

In some examples, the sensor comprises a microphone configured to detect an acoustic signal indicative of feet of the user impacting a surface. The controller may be configured to determine the exercise pace of the user based on the acoustic signal indicative of the feet of the user impacting the surface.

In some examples, the sensor comprises one of an inertial sensor or an accelerometer configured to detect accelerations associated with movement of the user. The controller may be configured to determine the exercise pace of the user based on measurements of the sensor.

In some examples, the physiological parameter of the user is one of a heartrate, a respiration rate, or a blood oxygen level of the user.

In some examples, the sensor is disposed in the headphones.

In some examples, the headphone system, further comprises an additional sensor disposed external to the headphones and configured to provide the controller with an indication of one of the exercise pace or the value of the physiological parameter of the user.

In some examples, the controller is programmed with an exercise routine having different portions with different target values of one of the exercise pace or the value of the physiological parameter, and the controller is configured to provide the feedback to the user during each of the different portions of the exercise routine.

In accordance with another aspect, there is provided a method of providing feedback to a user of headphones. The method comprises receiving an audio signal to be converted to an acoustic signal; receiving a sensor signal indicative of one of an aspect of the user's movement or a value of a physiological parameter of the user, analyzing the sensor signal to detect the one of the aspect of the user's movement or the value of the physiological parameter, and providing feedback based upon the one of the aspect of the user's movement or the value of the physiological parameter, the feedback including a location of a source of the audio signal perceived by the user.

In some examples, the method further comprises determining an exercise pace of the user from the aspect of the user's movement. The method may further comprise comparing one of the exercise pace of the user to a target exercise pace or the value of the physiological parameter to a target physiological parameter value and adjusting the perceived location of the source of the audio signal based on a result of the comparison.

In some examples, adjusting the perceived location of the source of the audio signal includes setting the perceived location of the audio signal in front of the user responsive to one of the exercise pace of the user being below the target exercise pace or the physiological parameter having a value below a target value.

In some examples, adjusting the perceived location of the source of the audio signal includes setting the perceived location of the audio signal behind the user responsive to the exercise pace of the user being above the target exercise pace or the physiological parameter having a value above a target value.

In some examples, receiving the sensor signal includes receiving the sensor signal from a sensor disposed within the headphones.

Still other aspects, examples, and advantages of these exemplary aspects and examples are discussed in detail below. Examples disclosed herein may be combined with other examples in any manner consistent with at least one of the principles disclosed herein, and references to “an example”, “some examples”, “an alternate example”, “various examples”, “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the disclosure. In the figures, identical or nearly identical components illustrated in various figures may be represented by a like numeral. For purposes of clarity, not every component may be labeled in every figure. In the figures:

FIG. 1 is a perspective view of an example headphone set;

FIG. 2 is a left-side view of an example headphone set;

FIG. 3 is a schematic diagram of an example headphone set;

FIG. 4A is a perspective view of an example set of earbuds;

FIG. 4B illustrates an example of a pair of wireless earbuds;

FIG. 5 is a cross-sectional view of an example of an earbud;

FIG. 6 is a flow chart of an example method that may be carried out by a headphone set;

FIG. 7 illustrates a user performing an example of an exercise routine; and

FIG. 8 is a schematic diagram of a signal processing method that may be carried out by a headphone set.

### DETAILED DESCRIPTION

Aspects and examples are directed to headphone systems and methods that detect aspects of a user's activity, such as running. Aspects and examples disclosed herein are not limited to detecting aspects of running, but may be equally applicable to any form of locomotion-based exercise activity, for example, but not limited to, rowing, bicycling, skiing, swimming, or performing an exercise activity on stationary exercise equipment, for example, a treadmill, rowing machine, stationary bicycle, elliptical trainer, stair machine, or a stationary ski machine. Various aspects and examples will be described herein with reference to running being the exercise activity of a user, however it is to be understood that these aspects and examples apply equally to any other type of exercise activity such as described above.

Aspects of running or other exercise activity may include the user's stride, gate, pace, and the like as well as physiological parameters of the user, for example, heartrate, respiration rate or quality, or blood oxygen level, among other physiological parameters. Headphone systems and methods disclosed herein may provide feedback to the user about the user's performance, and, in particular examples, may provide feedback intended to help the user adhere to a desired exercise program or activity or maintain a desired level of physical exertion during the exercise program or activity. Feedback may be provided through modification of one or more characteristics of audio content played through headphones a user wears while performing the exercise program or activity. In some examples, the audio content may include unique audio designed and provided specifically for the purpose of the most effective feedback to provide to the user. In other examples, modification of the one or more characteristics of the audio content may include modification of existing content (e.g., music on a phone of the user) that the user selects. In other examples the audio content may include specific content generated for providing the feedback to the user overlaid on top of an attenuated version of user selected content (e.g., music on a phone of the user).

Throughout this disclosure the terms “headset”, “headphone”, and “headphone set” are used interchangeably, and no distinction is meant to be made by the use of one term over another unless the context clearly indicates otherwise. Additionally, aspects and examples in accord with those disclosed herein may be applied to intra-ear earphone form factors (e.g., in-ear transducers or earbuds) and/or off-ear acoustic devices (e.g., devices that are designed to not contact a wearer's ears, but are worn in the vicinity of the wearer's ears, on the head or body, e.g., shoulders) and such are also contemplated by the terms “headset”, “headphone”, and “headphone set.” Accordingly, any on-ear, in-ear, over-ear, or off-ear form-factors of personal acoustic devices are intended to be included by the terms “headset”, “headphone”, and “headphone set.” The term “earpiece” is intended to include any portion of such form factors in proximity to at least one of a user's ears.

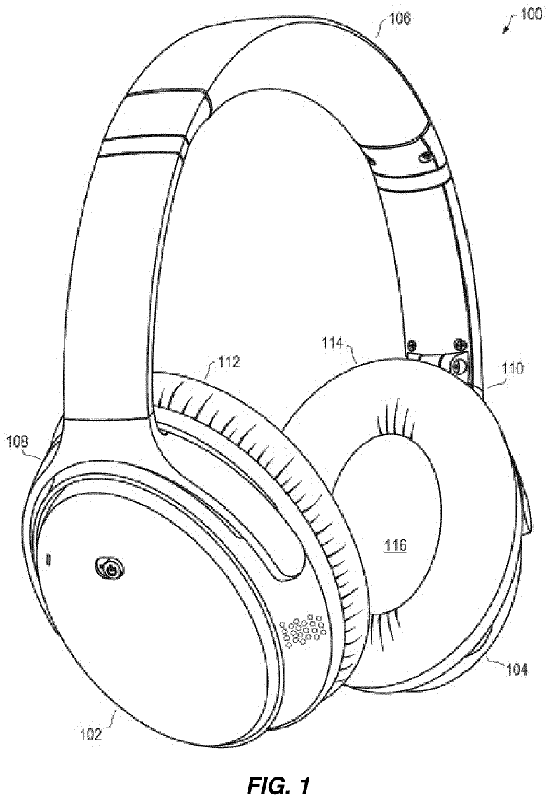

FIG. 1 illustrates one example of a headphone set. The headphones 100 include two earpieces, e.g., a right earcup 102 and a left earcup 104, coupled to a right yoke assembly 108 and a left yoke assembly 110, respectively, and intercoupled by a headband 106. The right earcup 102 and left earcup 104 include a right circumaural cushion 112 and a left circumaural cushion 114, respectively. Visible on the left earcup 104 is a left interior surface 116. While the example headphones 100 are shown with earpieces having circumaural cushions to fit around or over the ear of a user, in other examples cushions may sit on the ear, or may include earbud portions that protrude into a portion of a user's ear canal, or may include alternate physical arrangements, as discussed above. As discussed in more detail below, either of the earcups 102, 104 may include one or more sensors, such as microphones, inertial sensors (e.g., an accelerometer, gyroscope, or compass), radio receivers, etc. Accelerometers as disclosed herein may include multi-axis accelerometers that may provide signals associated with motion of a body of a user, for example, motion associated with steps of the user, as well as signals associated with turning or rotational movement of the user's head or body of the user. Although the example headphones 100 illustrated in FIG. 1 include two earpieces, some examples may include only a single earpiece for use on one side of the head only. Additionally, although the example headphones 100 include a headband 106, other examples may include different support structures to maintain one or more earpieces (e.g., earcups, in-ear structures, neckband, etc.) in proximity to a user's ear, e.g., an earbud may include a shape and/or materials configured to hold the earbud within a portion of a user's ear, or a personal speaker system may include a neckband to support and maintain acoustic driver(s) near the user's ears, shoulders, etc.

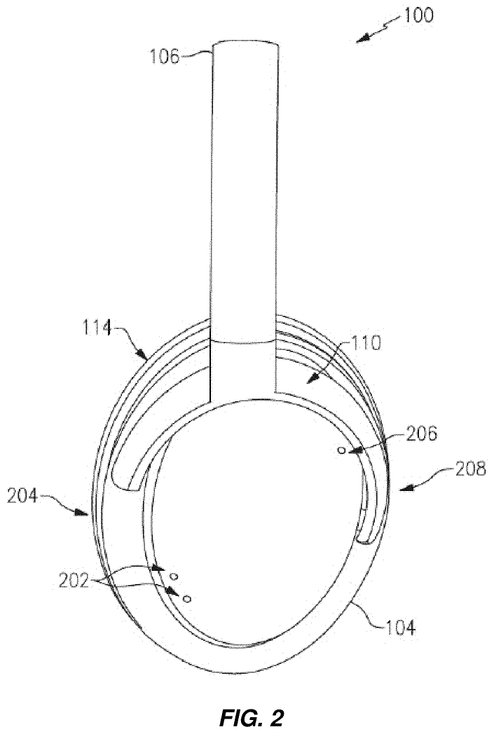

FIG. 2 illustrates multiple example placements of sensors on the headphones 100, any one or more of which may be included in certain examples. FIG. 2 illustrates the headphones 100 from the left side and shows details of the left earcup 104 including a pair of front sensors 202, which may be nearer a front edge 204 of the earcup, and a rear sensor 206, which may be nearer a rear edge 208 of the earcup. The right earcup 102 may additionally or alternatively have a similar arrangement of front and rear sensors, though in some examples the two earcups may have a differing arrangement in number or placement of sensors. Additionally, various examples may have more or fewer sensors 202, 206 in various placement about or internal to a headphone, which may include sensors on the headband 106, a neckband, chin strap, etc. In some examples, one or more sensors may be provided as an accessory sensor worn elsewhere on the user's body, such as in a shoe, wristband, or on a waistband, for instance. While not specifically illustrated in FIGS. 1 and 2, one or more acoustic drivers may be provided in the right and/or left earcups 102, 104 to provide audio playback to the user.

The sensors 202, 206 may be of various types, such as acoustic sensors (e.g., microphones, ultrasonic, sonar systems, etc.), inertial sensors, electromagnetic or radio sensors (e.g., radio receivers, radar devices, etc.), and may be coupled to additional sensor components, e.g., a force plate in a shoe may transmit a signal to one of the sensors 202, 206.

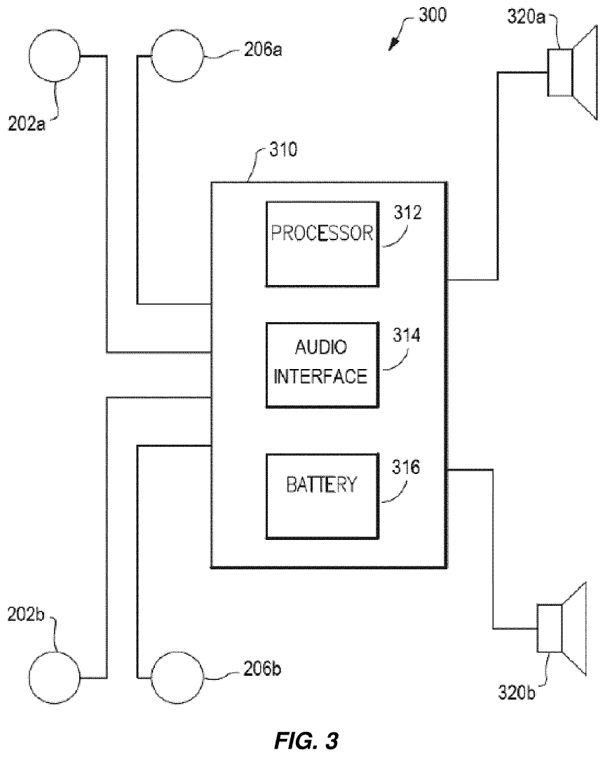

FIG. 3 is a schematic block diagram of an example headphone system 300, such as for the headphones 100. The headphone system 300 includes a controller 310 that provides signals to acoustic drivers 320 for audio playback (e.g., right driver 320a, left driver 320b). The controller 310 includes a processor 312, an audio interface 314, and may include a battery 316 and/or additional components. The audio interface 314, for example, may be a wired input or may be a wireless interface configured, at least in part, to receive program content signals for audio playback. The controller 310 may also receive signals from various sensors, including the sensors 202, 206 (see FIG. 2), for example. In some examples, one or more of the sensors 202, 206 may be acoustic sensors, such as microphones, and may provide microphone signals to be analyzed by the processor 312 to determine aspects of the user's performance. In various examples, one or more of the sensors 202, 206 may be an inertial sensor, to sense movement of the user's head or body for the processor 312 to determine the user's stride, exercise pace, etc. One or more of the sensors 202, 206 may be or may include an inertial sensor or accelerometer and act as a pedometer that provides input to the processor 312 to determine a user's exercise pace. In various examples, one or more of the sensors 202, 206 may be a radio or other electromagnetic sensor (e.g., antenna, Bluetooth™ receiver, etc.) and may be coupled with a further sensor component, such as a shoe mounted accelerometer or force sensor, wrist-worn sensor, waistband sensor, and/or other suitable sensors for detecting aspects of the user's movement or one or more physiological parameters of the user, for example, heartrate, respiration rate or quality, blood oxygen level, or other physiological parameters of interest.

In some examples, one or more of the sensors 202, 206 may be microphones whose signals are processed by the processor 312 to detect the sound of the user's feet impacting a running surface, for example, the ground or a treadmill platform, and determine an estimate of the user's exercise (e.g., running) pace. In some examples, various techniques may be applied to isolate the sound of the user's feet contacting the running surface. For example, array processing of the microphone signals may direct a beam toward the user's feet, and/or frequency band filtering may be applied to process only portions of the spectrum expected to have content related to the user's feet interacting with the ground, to name a few. In some examples, one or more of the sensors 202, 206 may be a microphone or microphones whose signals are processed by the processor 312 to detect the sound of the user's breathing (respiration) or heartbeat. The processor 312 may analyze the signals associated with the sound of the user's breathing or heartbeat to determine a respiration rate or heartrate of the user. The processor 312 may analyze the signals associated with the sound of the user's breathing to detect the presence of any sounds indicative of improper respiration, for example, uneven breathing, wheezing, or coughing. In some examples, one or more of the sensors 202, 206 may be inertial sensors whose signals may be processed by the processor 312 to detect motion indicative of the user's stride (e.g., up and down motion, timing of steps, strength of impact) and to determine an estimate of the user's exercise pace.

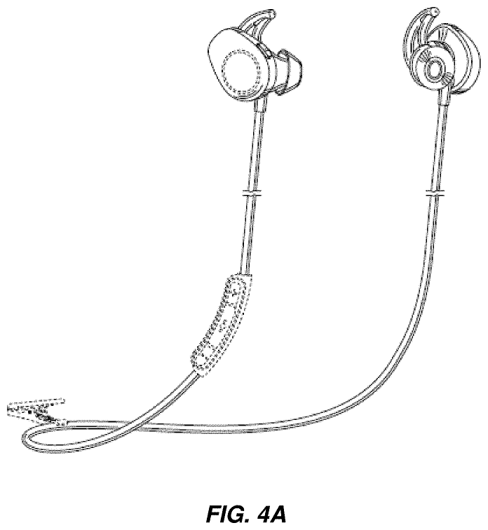

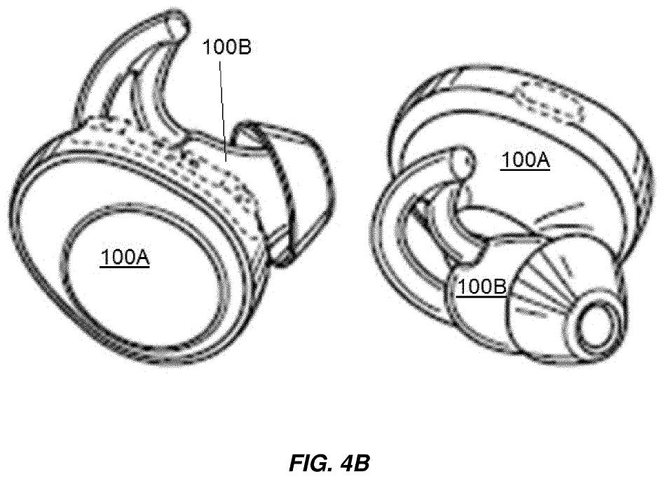

In some examples, various sensor types may provide signals that are analyzed in parallel, and results combined and/or correlated (e.g., for enhanced precision and/or confirmatory purposes), to determine an estimate of the user's exercise pace. For example, inertial sensor signals and microphone signals may be processed as discussed above and correlated with each other, to confirm timing and/or impact of the user's activity, or combined in a manner to increase precision. In some examples, one or more accessory sensors may provide sensor signals to be processed to determine an estimate of the user's exercise pace. For example, a shoe insert may measure force directly and may transmit a sensor signal to the headphones. In a further example, an inertial sensor worn elsewhere on the body (e.g., ankle-band, wrist-band, waistband) may transmit a sensor signal to the headphones. In further examples, a cardiologic monitor (e.g., heart-rate, blood pressure), electromyography sensor (e.g., muscle activity), or other physiological monitor may be worn by the user and may provide signals to the headphones. Any one or more of such sensor signals, individually or in combination, may be processed by the processor 312 to determine aspects of the user's physical activity and/or physiological state upon which to base feedback to be provided to the user. FIG. 4A illustrates another example of a form factor for an audio device that may be broadly described as a headphone herein. The audio device of FIG. 4A is a pair of “in-ear” audio devices or “intra-aural” audio devices, often referred to as “wireless earbuds” or simply “earbuds.” FIG. 4A illustrates a pair of earbuds be coupled by wiring to form a headset. Other examples may be mechanically separate, as illustrated in FIG. 4B. In various examples, the earbuds may include a canal portion or eartip that may be separable from a concha portion or may include a removable covering made of, for example, soft silicone to enhance comfort for a user. For example, in FIG. 4B, section 100A may include a rigid shell housing electronics such as an acoustic driver, wireless communication circuitry, one or more sensors as disclosed herein, battery, etc., while section 100B may be a removable eartip formed of a soft compliant material, for example, medical grade silicone.

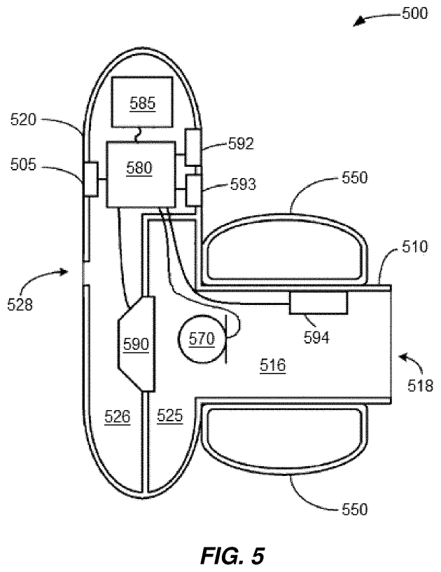

FIG. 5 illustrates a cross-section of an example of an earbud 500 that may be utilized in various aspects and examples disclosed herein. It is to be understood that the earbud 500 is shown in a schematic form and that the shape and relative sizes of the illustrated components are not intended to be limiting. For example, in some implementations, the earbud 500 may have a form factor like that illustrated in FIG. 4A or 4B, or the canal portion 510 may be angled relative to the concha portion 520 rather than extending straight from a surface of the concha portion 520 as illustrated.

The earbud 500 includes a casing made up of at least a canal portion 510 meant to be positioned within at least an entrance of an ear canal of a user's ear and a concha portion 520 meant to be positioned within at least a portion of the concha of the user's ear. The concha portion 520 may have a curved shape to fit within the concha of a user's ear while accommodating the shape of the concha as defined by portions of the tragus, anti-tragus, and anti-helix of the pinna of the ear. The canal portion 510 has a generally tubular shape extending from where one end of the canal portion 510 is coupled to the concha portion 520 at a location coincident with where the entrance to the ear canal is typically located in relation to the portion of the concha defined by portions of the tragus and anti-tragus. An aperture 518 is formed in the other end of the canal portion 510 to enable sounds to be acoustically output by an acoustic driver 590 positioned within the casing of the earbud 500 through the aperture 518 and into the ear canal when the earbud 500 is properly positioned in the ear of a user during operation. A soft eartip 550, formed of, for example, silicone may surround at least a portion of the canal portion 510 to enhance user comfort.

The implementation of the earbud 500 may be any of a variety of types of earbuds able to perform any of a variety of audio functions including, and not limited to, an in-ear earphone to acoustically output audio, an in-ear acoustic noise reduction (ANR) device to provide a reduction in environmental noise sounds encountered by a user through the acoustic output of anti-noise sounds, and/or a two-way communications audio device employing detection of the user's speech sounds through bone conduction and/or a Eustachian tube connected to portions of the ear into which the in-ear audio device 500 is inserted.

The earbud 500 may receive audio through a wired or wireless coupling with another device. Accordingly, electrical and electronic components such as, but not limited to, a wireless receiver and/or transmitter, processor (optionally including ANR circuitry), battery, microphone, and acoustic driver may be included within the concha portion 520 and/or canal portion 510 of the earbud 500. Alternatively, such components may be included within a housing or casing coupled to the earbud.

The earbud 500 may incorporate circuitry 580 and an acoustic driver 590 that is electrically coupled to the circuitry 580. The circuitry 580 may include, or be coupled to, one or more sensors, for example, an accelerometer (e.g., a MEMS accelerometer), inertial sensor, or gyroscope. The circuitry 580 may include the processor 312 and/or audio interface 314 illustrated in FIG. 3. Within the canal portion 510, a channel 516 is formed that extends from the aperture 518 through to an interior portion 525 of the concha portion 520. Within the concha portion 520, the interior portion 525 is separated by a wall structure and the acoustic driver 590 from another interior portion 526 in which the circuitry 580 is depicted as being disposed (though it should be noted that the circuitry 580 may be disposed in any of a variety of locations either within the casing of the earbud 500, or externally thereof). The earbud 500 further include a battery 585 (which may be battery 316 illustrated in FIG. 3) to power the various components and wireless communication circuitry built into the circuitry 580 or a separate circuit element (though this may also be located in a housing separate from earbud 500). The earbud 500 may also include a microphone 570 that is acoustically coupled to the channel 516 and/or the interior portion 525 and electrically coupled to the circuitry 580 for providing two-way communications through the earbud 500 or feedback-based ANR. The microphone 570 may additionally or alternatively be used to detect sounds associated with respiration or heartbeat of the user and provide signals indicative of the sounds associated with respiration or heartbeat of the user to the circuitry 580 or processor 312 (FIG. 3). Optionally, the earbud 500 may be activated or deactivated with a manually operable power switch 505.

The earbud 500 is depicted as having an aperture 528 formed between the interior portion 526 and the environment external to a user's ear. One or more of the apertures 528 may serve as acoustic ports to tune the frequency response of the acoustic driver 590 and/or may serve to enable equalization of air pressure between the ear canal and the external environment. The apertures 528 may have dimensions and/or other physical characteristics selected to acoustically couple portions within the casing of the earbud 500 to each other and/or to the external environment within a selected range of frequencies. Further, one or more damping elements (not shown) may be disposed within one or more of the apertures 528 to cooperate with characteristics of the acoustic driver 590 to alter frequency response.

Additionally or alternatively, one or more of the apertures 528 may be formed in the concha portion 520 (and/or in other portions of the casing) to provide a controlled acoustic leak between the ear canal and the external environmental for purposes of controlling the effects of variations in fit that may develop over time. As will be recognized by those skilled in the art, variations in the health or other aspects of the physical condition of a user can bring about minor alterations in the dimensions and/or shape of the ear canal over time such that the quality of the seal able to be formed with each insertion of the earbud 500 into the ear over time may degrade. Thus, in some implementations, the dimensions and/or other characteristics of one or more apertures 528 formed in the casing may be selected to aid in mitigating the effects of a slightly degraded quality of seal by providing a pre-existing leak of controlled characteristics that mitigates the acoustic effects of other leaks developing in the future in the seal between the casing of the earbud 500 and portions of the ear. For example, the dimensions of one or more apertures 528 may be selected to be large enough to provide a far greater coupling between the ear canal and the external environment than any other coupling through a leak in the seal that may develop at a later time.

The earbud 500 may include one or more sensors to measure or monitor one or more physiological parameters of the user. One of these sensors may be microphone 570, which, as discussed above may be utilized to detect sounds associated with the heartbeat and/or respiration of the user. Other sensors may include one or more of sensors 592, 593, and/or 594, which may be utilized to measure a pulse rate or blood oxygen level of the user. Sensors 570, 592, 593, and 594 may be any of sensors 202a, 202b, 206a, or 206b illustrated in FIG. 3. Sensors 592 and 593 may include an infrared (IR) transmitter 592 and an IR receiver 593. The IR transmitter 592 and IR receiver 594 may both be electrically coupled to the circuitry 580 and may receive drive signals (IR transmitter 592) from the circuitry 580 or send indications of detected IR light signals (IR receiver 594) to the circuitry 580. The pattern and intensity of the detected IR light signals may be used to determine the pulse rate of the user based on changes in IR absorption of the flesh of the user due to patterns of blood perfusion associated with the user's pulse. Sensors 592 and 593 may also or alternatively function as a blood oximeter and a pattern and intensity of the detected IR light signals may be used to determine parameters such as blood oxygen levels of the user. Sensors 592 and 593 may alternatively include conductive contacts and may be used to measure parameters such as skin resistance of the user that may be indicative of the heartrate of the user. Sensor 594 may be disposed within the canal portion 510 of the earbud 500 and may be a transceiver (e.g., an IR transceiver) or other form of sensor that can perform the functions of both sensors 592 and 593 or that may perform different measurements than sensors 592 and 593. The specific location of the sensors 592, 593, or 594 within the canal portion 510 or concha portion 520 of the earbud 500 shown is merely exemplary, and other locations within the earbud 500 may alternatively be used. The one of the sensors 592, 593 disposed on the concha portion 520 of the earbud may be mounted flush with a surface of the concha portion 520 to enhance user comfort. When the sensor 594 is an IR transmitter or transceiver disposed within the canal portion 510 of the earbud 500 it is positioned and arranged to transmit IR light out of the aperture 518 of the canal portion 510 and/or receive IR light through the aperture 518 of the canal portion 510. In examples in which sensor 592 is an IR transmitter disposed on the concha portion 520 of the earbud 500 it is positioned and arranged to transmit IR light in a direction toward where a surface of the ear of a user would be when the earbud 500 was inserted in the ear of the user, for example, generally parallel to or in the same general direction as the canal portion 510.

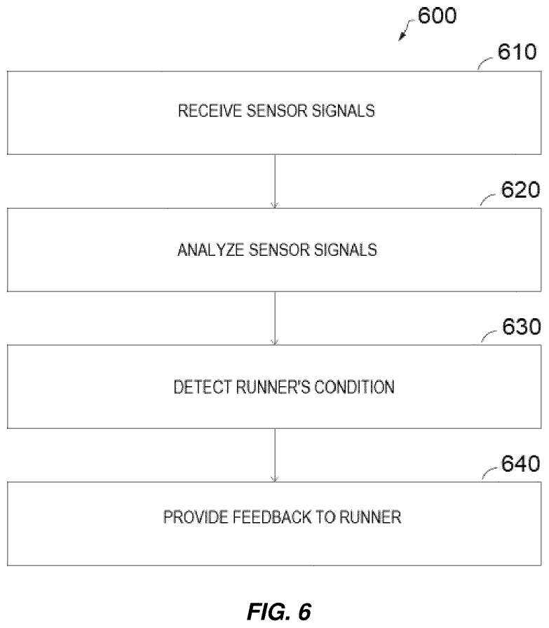

FIG. 6 illustrates an example method 600 that may be implemented by various headphone systems, such as the headphones 100 or earbud 500 and the headphone system 300. A controller or processing system, such as the controller 310, receives signals from one or more sensors (block 610), and analyzes the signals (block 620) to detect a condition of the user (block 630), e.g., to evaluate or determine an aspect of the user's physical motion and/or physiological condition. Upon evaluation (which may optionally be characterized into various levels of significance, in some examples), the controller or processing system may provide feedback (block 640) or an instruction to the user.

For example, the controller or processing system may modify an audio signal to be rendered by an acoustic driver of a headphone system worn by a user engaging in an exercise activity to provide a message, such as “speed up”, “slow down”, “keep going”, or “stop” or any of various messages as determined by an appropriate program function taking into account various best practices for, e.g., exercise pace or levels of a monitored physiological parameter of the user. An exercise program may be stored in a memory of the controller or processing system or a piece of exercise equipment the user is utilizing, and may include either a steady state target pace or exertion level or different portions having different target paces or exertion levels to simulate, for example, climbing a hill during some portions of the exercise program and running on a straightway during other portions of the exercise program. The message may be based on a comparison between the pace or exertion level of the user and a target pace or exertion level associated with a portion of an exercise program in which the user in engaging. If the user is progressing (e.g., running) at a pace slower than that indicated as a target pace in the portion of the exercise program, or is exerting less energy (e.g., as determined from the user's heart rate, blood oxygen level, or respiration rate, or other measured physiological parameter) than that indicated as a target exertion level in the portion of the exercise program, the controller or processing system may provide a message for the user to speed up. Conversely, if the user is progressing (e.g., running) at a pace greater or faster than that indicated as a target pace in the portion of the exercise program, or is exerting more energy than that indicated as a target exertion level in the portion of the exercise program, the controller or processing system may provide a message for the user to slow down. If the user is progressing (e.g., running) at a pace consistent with that indicated as a target pace in the portion of the exercise program, or is exerting energy consistent with that indicated as a target exertion level in the portion of the exercise program, the controller or processing system may provide a message for the user to keep going.

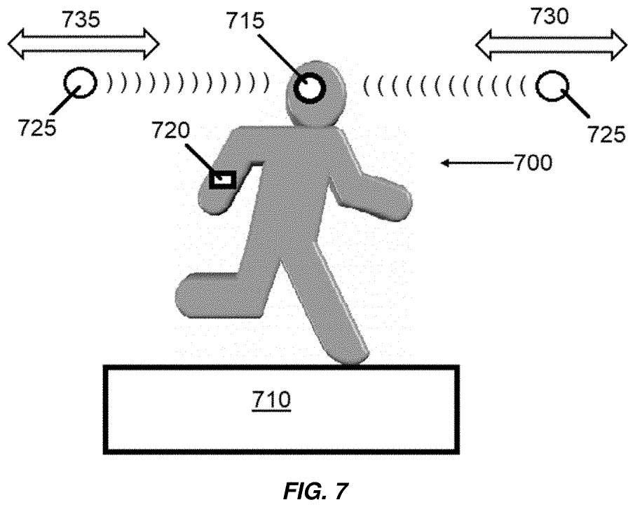

The message from the controller or processing system (e.g., processor 312 or circuitry 580) may be provided in the form of an adjustment in an apparent location of origin of the audio signal rendered by the acoustic drivers of the headphone system worn by the user engaging in the exercise activity. For example, as illustrated in FIG. 7, a user 700 may be performing an exercise routine (running, stair climbing, or rowing, etc.) either on his own or utilizing a piece of exercise equipment 710. The user 700 may be wearing a pair of headphones 715, such as headphones 100 or earbuds 500, rendering audio content to the user 700 while the user is performing the exercise activity. The headphones 715 may include sensors to detect body movements of the user, for example, a running pace of the user as well as one or more physiological parameters (heartrate, respiration rate, blood oxygen level, etc.) of the user. Additionally or alternatively, the user 700 may be wearing one or more sensors, for example, a wrist-worn external sensor 720 that may provide information regarding the body movements and/or physiological parameters to the controller or processing system and/or augment sensor information provided from sensors incorporated in the headphones 715. The exercise equipment 710 may also include one or more sensors, for example, speed sensors or pulse rate sensors that may provide an additional or alternative source of body movement and/or physiological parameter information to the controller or processing system.

The controller or processing system compares the body movement (e.g., exercise pace) and/or physiological parameter information received from the various sensors in the headphones, external sensor 720, and/or exercise equipment 710 to a target pace or target physiological parameter (e.g., exertion level) associated with a portion of the exercise program the user is performing. If the controller determines that the user is exercising at a pace or exertion level below the target pace or exertion level, the controller or processing system may adjust the audio signal rendered by the acoustic driver of the headphone system worn by the user engaging in the exercise activity such that the audio signal is perceived by the user as originating at a virtual audio source 725 ahead of the user. The apparent location of the audio source 725 may be adjusted (arrow 730) by the controller or processing system based on how far from target the user's pace or exertion level is from that programmed in the exercise routine. The farther behind target the user's pace or exertion level is, the farther from the user the virtual source of audio 725 may be made to be perceived by the user. The user may be encouraged to speed up or exert more energy to bring the virtual source of audio 725 closer to the user.

If the controller or processing system determines that the user is exercising at a pace or exertion level above or greater than the target pace or exertion level, the controller or processing system may adjust the audio signal rendered by the acoustic driver of the headphone system worn by the user engaging in the exercise activity such that the audio signal is perceived by the user as originating at a virtual audio source 725 behind the user. The apparent location of the audio source 725 may be adjusted (arrow 735) by the controller or processing system based on how far from target the user's pace or exertion level is from that programmed in the exercise routine. The farther ahead of target the user's pace or exertion level is, the farther from the user the virtual source of audio 725 may be made to be perceived by the user. The user may be encouraged to slow down or exert less energy to bring the virtual source of audio 725 closer to the user.

The terms “ahead of” and “behind” as used herein correspond to a direction of movement or simulated movement of the user, and a direction opposite to the direction of movement or simulated movement of the user, respectively. Thus, a virtual audio source provided behind a user performing a rowing exercise may be located in the direction the user is facing and vice-versa.

If the controller or processing system determines that the user is experiencing an undesirable physiological state, for example, ragged or wheezing breathing, or a heart rate that is above a safe level, the controller may adjust the audio signal rendered by the acoustic drivers of the headphone system worn by the user engaging in the exercise activity to, for example, provide a warning message or tone, or terminate rendering of the audio content.

In other examples, the controller or processing system may provide an indication of the exercise program for a user coming to an end, for example, by reducing the volume of the rendered audio.

The location of the virtual source of audio 725 perceived by the user may be set or altered by the controller or processing system in a number of ways. In some examples, the volume or the pitch of the rendered audio may be adjusted to provide a perception of the location of the audio source moving. In one example, the pitch of the audio signal may be lessened to mimic a Doppler effect and the volume of the rendered audio may be lessened to simulate the audio source moving away from the user. The pitch of the audio signal may be increased, and the volume of the rendered audio may be increased to simulate the audio source moving toward the user. In other examples, different equalization or relative phases may be applied to different frequency bands of the rendered audio to provide the user with a perception of a location of the virtual source of audio 725. A near-field virtual audio source (close to the user) will have signals that arrive at the two ears of the user with a certain phase and time alignment; virtually moving the audio source away from the user will cause the higher frequencies to begin arriving according to far-field acoustics before the low frequencies do—A signal at 200 Hz has a wavelength of about 1.7 meters while 20,000 Hz has a wavelength of about 1.7 cm, thus high frequencies may be far-field when they come from only a number of inches away while lower frequencies have to be much farther away. Accordingly, a desired transfer function or filter may be applied to left and right-side audio drivers of the headphones worn by the user to adjust phase arrival of different frequencies to create the desired perception of location of the virtual source of audio 725.

While performing an exercise routine, a user may turn their head occasionally to look at objects in the environment around them. The turning of the user's head may be detected by an accelerometer, inertial sensor, or gyroscope or other form of motion sensor included in the headphones 715 of the user. The amplitude and/or relative phase alignment of different frequency bands in the rendered audio signals in the right and left-side audio drivers of the headphones 715 may be adjusted responsive to detection of the turning of the user's head to provide a further indication of a location of the virtual source of audio 725. For example, if the virtual source of audio 725 is ahead of the user and the user turns his head to the right, the right-side audio driver may then be closer to the virtual source of audio 725 than the left side audio driver. The amplitude or volume of the audio signal rendered by the right-side audio driver may be increased relative to the amplitude or volume of the audio signal rendered by the left-side audio driver to give the user the perception of the virtual audio source being ahead of the user. If the user turns his head to the left, the amplitude or volume of the audio signal rendered by the left-side audio driver may be increased relative to the amplitude or volume of the audio signal rendered by the right-side audio driver to give the user the perception of the virtual audio source being ahead of the user. If the virtual source of audio 725 is behind the user and the user turns his head to the right, the right-side audio driver may then be farther to the virtual source of audio 725 than the left side audio driver. The amplitude or volume of the audio signal rendered by the right-side audio driver may be decreased relative to the amplitude or volume of the audio signal rendered by the left-side audio driver to give the user the perception of the virtual audio source being behind the user. If the user turns his head to the left, the amplitude or volume of the audio signal rendered by the left-side audio driver may be decreased relative to the amplitude or volume of the audio signal rendered by the right-side audio driver to give the user the perception of the virtual audio source being behind the user.

There are three primary cues that contribute to perception of the spatial localization of a sound source by a user. These cues include: internal time difference (ITD), which is a measure of when the sound arrives at the left vs. the right ear canal; internal level difference (ILD), which is the difference in pressure levels between the left and right ears; and spectral cues from the pinnae; the shape of the pinnae change the spectral profile of a sound according to the origin of the sound source.

Given a two-channel system like that in a set of headphones, accompanied by continuous head tracking information an audio signal can be modified so that the timing and pressure across the left and right ear are modified to sound like the source of the audio is at a given spatial location through the application of head related transfer functions (HRTFs).

In some examples, the controller or processing system may distinguish between a turning of the user's head to look at something versus a turn of the entire body of the user, for example, to follow a turn in an exercise path. In some examples, the user may be wearing different systems, for example, headphones and a wrist or chest-worn sensor system, each with an accelerometer, inertial sensor, gyroscope, or different form of motion or direction sensor. Signals from the direction sensors of the different systems may be compared. If the signals from the direction sensors of the different systems agree the controller or processing system may interpret the sensor signals as indicative of the user taking a turn in an exercise path rather than turning his head and may thus not utilize the indication of the turning of the users head to provide the user with the perception of the location of the virtual audio source as described above. If the signals from the direction sensors of the different systems disagree the controller or processing system may interpret the sensor signals as indicative of the user turning his head and may thus utilize the indication of the turning of the user's head to provide the user with the perception of the location of the virtual audio source as described above.

In other examples, if the controller or processing system receives an indication from a motion or direction sensor in the headphones consistent with the user turning his head, the controller or processing system may apply dynamic filtering with a delay function to move the perceived location of the virtual audio source directly in front of or behind of the new direction the user's head is facing. The delay function may move the perceived location of the virtual audio source if the change in direction the user is facing stays constant over a time period of, for example, more than one second, five seconds, or more, which may be indicative of the user having navigated a turn in an exercise path rather than turning his head for a short period of time to observe something in the environment about the user.

Accurately tracking head movement relative to body position may involve utilization of a tertiary sensor in addition to sensors proximate each ear of a user, for example, in headphones worn by the user. The tertiary sensor may be worn somewhere on the body or on a limb, for example, where the processing unit is; i.e. a smart device, or in a wrist-worn external sensor 720 as illustrated in FIG. 7. The relative acceleration of the head could then be subtracted from that of the body to calculate if the head is moving relative to the body through the use of gyroscope/accelerometer data. Alternatively, the headphones could produce a magnetic field and the sensor on the body could be sensitive to differences in magnetic field strength (i.e. the angle of the field) and use the differences in magnetic field strength to determine the relative orientation of the head to the body. In addition to these methods, data collected from a varied set of human subjects engaging in target activities can allow a model of predicted relationships with respect to these data points to further help with their accuracy since the relative orientation of one part of the body relative to the head only has so many possible orientations across individuals of different heights and girths.

In some examples, a controller or processing system, such as the controller 310, may be programmed or trained to provide proper feedback or instruction to a user through artificial intelligence and/or machine learning processes, and such programming or training may be performed at manufacture for a general or average user, or may be customized by the user and/or performed through a procedure executed by the user. In some examples, a user's desired exercise pace and/or level of physical exertion may be exhibited (or performed) while wearing the headphones, and the controller 310 may “learn” the proper sensor signals that indicate the proper performance. For example, inertial sensor signals and/or the sound of the user's feet (via microphone, acoustic sensors) and/or heartrate and/or respiration rate may be monitored and characterized such that proper pace and/or level of physical exertion, and improper pace and/or level of physical exertion, may be determined in the future by comparison to the “learned”, characterized, or exemplary sensor signals.

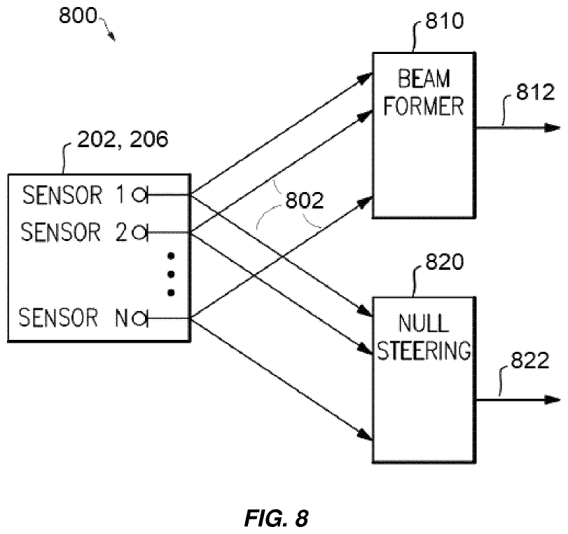

In some examples, a controller such as the controller 310 may process signals from various sensors (e.g., sensors 202, 206) in a manner to provide enhanced and/or reduced response in certain directions, e.g., via array processing techniques. For example, and as illustrated in FIG. 8, an example processing method 800 is shown. The sensors 202, 206 may provide two or more individual signals 802 to be combined with array processing, e.g., by the controller 310, to implement a beam former 810 to produce a signal 812 having enhanced response in a particular beam direction. Additionally or alternatively, two or more of the individual signals 802 may be combined with array processing, e.g., by the controller 310, to implement null steering 820 to produce a signal 822 having reduced response in a particular null direction. The signal 812 may be produced with an enhanced response in a selected direction, such as toward the feet of the user, for example, to enhance the likelihood of detection of running acoustics, e.g., foot impact. In some examples, the signal 822 may be a reference signal. For example, to confirm that an acoustic sound is coming from a certain direction (e.g., the user's foot, as directed by the beam former 810), the signal 822 may be formed by null steering 820 to have reduced response in the direction of the user's foot. Accordingly, a signal component present in the signal 812 but absent from the signal 822 may provide confidence that the signal component is originating in the direction of the user's foot. In various examples, signals from acoustic sensors (microphones) may be array processed in a manner illustrated by the example shown in FIG. 8, while in broader examples signals of various types may be array processed in an analogous manner.

In various examples, any of the functions or methods, and any components of systems (e.g., the controller 310), described herein may be implemented or carried out in a digital signal processor (DSP), a microprocessor, a logic controller, logic circuits, and the like, or any combination of these, and may include analog and/or digital circuit components and/or other components with respect to any particular implementation. Functions and components disclosed herein may operate in the digital domain and certain examples include analog-to-digital (ADC) conversion of analog signals provided, e.g., by microphones, despite the lack of illustration of ADC's in the various figures. Any suitable hardware and/or software, including firmware and the like, may be configured to carry out or implement components of the aspects and examples disclosed herein, and various implementations of aspects and examples may include components and/or functionality in addition to those disclosed.

Examples disclosed herein may be combined with other examples in any manner consistent with at least one of the principles disclosed herein, and references to “an example”, “some examples”, “an alternate example”, “various examples”, “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising”, “having”, “containing”, “involving”, and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having described above several aspects of at least one example, it is to be appreciated various alterations, modifications, and improvements will readily occur to those skilled in the art. Such alterations, modifications, and improvements are intended to be part of this disclosure and are intended to be within the scope of the disclosure. Accordingly, the foregoing description and drawings are by way of example only, and the scope of the disclosure should be determined from proper construction of the appended claims, and their equivalents.

What is claimed is:

1. A headphone system, comprising:
headphones including:
a right-side earpiece including a right-side audio driver; and
a left-side earpiece including a left-side audio driver;
a sensor to provide a sensor signal indicative of one of an aspect of movement of a user wearing the headphones or a value of a physiological parameter of the user;
a controller configured to output an audio signal via the headphones and to distinguish between a turning of a head of a user wearing the headphones versus turning of a body of the user; and
a detection circuit configured to receive the sensor signal and to provide feedback based on the one of the aspect of movement of the user or the value of the physiological parameter, the feedback including a location of a source of the audio signal perceived by the user, the location of the source of the audio signal determined in part by the distinguishing between the turning of the head of the user versus the turning of the body of the user.

2. The headphone system of claim 1, wherein the controller is configured to determine an exercise pace of the user based on measurements from the sensor of the aspect of movement of the user.

3. The headphone system of claim 2, wherein the controller is configured to compare one of the exercise pace of the user to a target exercise pace or the value of the physiological parameter to a target physiological parameter value and to adjust the perceived location of the source of the audio signal based on a result of the comparison.

4. The headphone system of claim 3, wherein the controller is configured to set the perceived location of the audio signal in front of the user responsive to one of the exercise pace of the user being below the target exercise pace or the physiological parameter having a value below a target value.

5. The headphone system of claim 4, wherein the controller is configured to set the perceived location of the audio signal behind the user responsive to the exercise pace of the user being above the target exercise pace or the physiological parameter having a value above a target value.

6. The headphone system of claim 5, wherein the sensor comprises a microphone configured to detect an acoustic signal indicative of feet of the user impacting a surface.

7. The headphone system of claim 6, wherein the controller is configured to determine the exercise pace of the user based on the acoustic signal indicative of the feet of the user impacting the surface.

8. The headphone system of claim 5, wherein the sensor comprises one of an inertial sensor or an accelerometer configured to detect accelerations associated with movement of the user.

9. The headphone system of claim 8, wherein the controller is configured to determine the exercise pace of the user based on measurements of the sensor.

10. The headphone system of claim 5, wherein the physiological parameter of the user is one of a heartrate, a respiration rate, or a blood oxygen level of the user.

11. The headphone system of claim 5, wherein the sensor is disposed in the headphones.

12. The headphone system of claim 11, further comprising an additional sensor disposed external to the headphones and configured to provide the controller with an indication of one of the exercise pace or the value of the physiological parameter of the user.

13. The headphone system of claim 5, wherein the controller is programmed with an exercise routine having different portions with different target values of one of the exercise pace or the value of the physiological parameter, and the controller is configured to provide the feedback to the user during each of the different portions of the exercise routine.

14. A method of providing feedback to a user of headphones, the method comprising:
receiving an audio signal to be converted to an acoustic signal;
receiving a sensor signal indicative of one of an aspect of the user's movement or a value of a physiological parameter of the user;
analyzing the sensor signal to detect the one of the aspect of the user's movement or the value of the physiological parameter and to distinguish between a turning of a head of the user wearing the headphones versus turning of a body of the user; and
providing feedback based upon the one of the aspect of the user's movement or the value of the physiological parameter, the feedback including a location of a source of the audio signal perceived by the user, the location of the source of the audio signal determined in part by the distinguishing between the turning of the head of the user versus the turning of the body of the user.

15. The method of claim 14, further comprising determining an exercise pace of the user from the aspect of the user's movement.

16. The method of claim 15, further comprising comparing one of the exercise pace of the user to a target exercise pace or the value of the physiological parameter to a target physiological parameter value and adjusting the perceived location of the source of the audio signal based on a result of the comparison.

17. The method of claim 15, wherein adjusting the perceived location of the source of the audio signal includes setting the perceived location of the audio signal in front of the user responsive to one of the exercise pace of the user being below the target exercise pace or the physiological parameter having a value below a target value.

18. The method of claim 16, wherein adjusting the perceived location of the source of the audio signal includes setting the perceived location of the audio signal behind the user responsive to the exercise pace of the user being above the target exercise pace or the physiological parameter having a value above a target value.

19. The method of claim 16, wherein receiving the sensor signal includes receiving the sensor signal from a sensor disposed within the headphones.

20. The headphone system of claim 1, further comprising a second sensor configured to be worn by the user, the controller configured to distinguish between the turning of the head of the user versus the turning of the body of the user by comparison of the signal from the sensor and a second signal from the second sensor.
